(19) United States
(12) Patent Application Publication
(10) Pub. No.: US 2015/0193228 A1
(43) Pub. Date: Jul. 9, 2015

(54) UNIFIED PLANNING FOR APPLICATION LIFECYCLE MANAGEMENT

(71) Applicant: International Business Machines Corporation, Armonk, NY (US)

(72) Inventors: Muhtar B. Akbulut, Waban, MA (US); Vivek Garg, Concord, MA (US); Mario A. Maldari, Longmont, CO (US); John D. Wiegand, Wilsonville, OR (US)

(21) Appl. No.: 14/495,992

(22) Filed: Sep. 25, 2014

Related U.S. Application Data
(63) Continuation of application No. 14/150,971, filed on Jan. 9, 2014.

(51) Int. Cl. G06F 9/44

(52) U.S. Cl. CPC G06F 8/70

(57) ABSTRACT

A computer-implemented method, computer program product, and computing system are provided for planning activities across multiple application lifecycle management tools, using actionable items and effort units native to each application. In an implementation, a method may include receiving one or more actionable items from at least one of a plurality of application lifecycle management tools. The method may also include associating, a priority with each of the one or more actionable items. The method may also include estimating a resource allocation necessary to accomplish each of the one or more actionable items.

### TECHNICAL FIELD

The present disclosure generally relates to systems and method for planning activities across multiple application lifecycle management tools.

### BACKGROUND

Software products may typically progress through a number of different stages throughout the life of the software product. For example, a software product may undergo various initial, and subsequent, development stages in which the features or requirements for the software product may be defined and the software code supporting those features and requirements may be written. The software code may be tested, for example, both to determine how effectively the software performs the desired functions, as well as to identify any errors or problems with the software product. Any identified defects, such as errors or problems, in the software code may be fixed or corrected. Various additional and/or alternative stages may also be included in the development, release, and revision of software products. The various stages may be sequential and/or may overlap, or be concurrent, with one another. Various tools may be utilized in connection with each of the different development stages of the software product development. The different tools may often be provided be different vendors, and/or may otherwise not provide a high degree of interoperability.

### SUMMARY OF DISCLOSURE

According to an implementation, a computer-implemented method may include receiving one or more actionable items from at least one of a plurality of application lifecycle management tools. The method may also include associating a priority with each of the one or more actionable items. The method may further include estimating a resource allocation necessary to accomplish each of the one or more actionable items.

One or more of the following features may be included. Receiving the one or more actionable items may include receiving the one or more actionable items includes executing a query across a cross tool data store including application lifecycle management tool artifacts. Associating the priority with each of the one or more actionable items may include receiving a user ranking of the one or more actionable items relative to at least another actionable item.

Estimating the resource allocation necessary to accomplish each of the one or more actionable items may include mapping a native effort unit associated with each of the one or more actionable items with a normalized effort unit. Mapping the native effort unit to the normalized effort unit may be based upon, at least in part, historical data associated with the performance of the native effort unit. The historical data associated with the performance of the native unit may be based upon, at least in part, one or more identified users.

The method may also include generating a prioritized plan including the one or more actionable items ranked based upon, at least in part, the associated priority for each of the one or more actionable items.

According to another implementation, a computer program product may include a computer readable medium having a plurality of instructions stored on it. When executed by a processor, the instructions may cause the processor to perform operations including receiving one or more actionable items from at least one of a plurality of application lifecycle management tools. Instructions may also be included for associating, a priority with each of the one or more actionable items. Instructions may further be included for estimating a resource allocation necessary to accomplish each of the one or more actionable items.

One or more of the following features may be included. The instructions for receiving the one or more actionable items may include instructions for receiving the one or more actionable items includes executing a query across a cross tool data store including application lifecycle management tool artifacts. The instructions for associating the priority with each of the one or more actionable items may include instructions for receiving a user ranking of the one or more actionable items relative to at least another actionable item.

The instructions for estimating the resource allocation necessary to accomplish each of the one or more actionable items may include instructions for mapping a native effort unit associated with each of the one or more actionable items with a normalized effort unit. Mapping the native effort unit to the normalized effort unit may be based upon, at least in part, historical data associated with the performance of the native effort unit. The historical data associated with the performance of the native unit may be based upon, at least in part, one or more identified users.

Instructions may further be included for generating a prioritized plan including the one or more actionable items ranked based upon, at least in part, the associated priority for each of the one or more actionable items.

According to another implementation, a computing system includes a processor device and a memory module coupled with the processor device. The processor device may be configured for receiving one or more actionable items from at least one of a plurality of application lifecycle management tools. The processor may also be configured for associating, a priority with each of the one or more actionable items. The processor may also be configured for estimating a resource allocation necessary to accomplish each of the one or more actionable items.

One or more of the following features may be included. Receiving the one or more actionable items may include receiving the one or more actionable items includes executing a query across a cross tool data store including application lifecycle management tool artifacts. Associating the priority with each of the one or more actionable items may include receiving a user ranking of the one or more actionable items relative to at least another actionable item.

Estimating the resource allocation necessary to accomplish each of the one or more actionable items may include mapping a native effort unit associated with each of the one or more actionable items with a normalized effort unit. Mapping the native effort unit to the normalized effort unit may be based upon, at least in part, historical data associated with the performance of the native effort unit.

The processor device may be further configured for generating a prioritized plan including the one or more actionable items ranked based upon, at least in part, the associated priority for each of the one or more actionable items.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a planning process according to an implementation of the present disclosure;

FIG. 2 is a flowchart of the planning process of FIG. 1, according to an implementation of the present disclosure;

FIG. 3 is diagrammatic representation of an example planning process of FIG. 1, according to an implementation of the present disclosure;

FIG. 4 is a diagrammatic representation of a user interface associated with the planning process according to an implementation of the present disclosure; and

FIG. 5 is a diagrammatic view of the computing device of FIG. 1, according to an implementation of the present disclosure.

Like reference symbols in the various drawings indicate like elements.

### DETAILED DESCRIPTION

Various tools may be implemented in support various application development tasks or domains, such as developing requirements, identifying and correcting defects or bugs in the software product, and the like. The various development domains may be at least partially concurrent with other development domains, and/or may be at least partially sequential with some other development domains. The various tools that may be implemented in support of the various application development domains may be referred to as Application Lifecycle Management (ALM) tools. For example, a requirements management tool may be utilized in defining the requirements of the software, a testing management tool may be utilized for testing the software product, e.g., to determine whether the software products performs as desired, while a defects management tool may be utilized for correcting identified defects or bugs in the software product.

In many situations, the various ALM tools may be provided by different vendors and/or may otherwise not be fully compatible, for example, in the manner in which the different ALM tools log and present information regarding the software product, in how the different ALM identify and manage resources, users, tasks, and/or other attributes associated with the software product development and management. As such, the different ALM tools may use different units and language to represent similar concepts. According to an implementation, the present disclosure may provide a cross-tool planning system that may, for example, allow a plan to be generated that may keep track of the prioritization of actionable items for each of a plurality of ALM tools, and may provide a unified view of the resources that will perform the work associated with each actionable item. In some embodiments, updates to the cross-tool plan may be provided as updates to artifacts in the associated ALM tools themselves. In some embodiments, the work necessary to complete each actionable item may be represented in native units implemented by the different respective ALM tools, which may differ from one another. In some implementations, the plan may additionally, and/or alternatively, represent the work necessary to complete each actionable item using a normalized unit, e.g., which may be the same across all of the ALM tools, regardless of the units utilized by each respective ALM tool.

Consistent with the foregoing, in some implementations, the present disclosure may enable a homogenized place across multiple ALM tools to be developed, which may allow native artifacts of each ALM tool, units of each ALM tool, and the language of each ALM tool to be utilized. Accordingly, it may be possible to reduce and/or eliminate the need to create artificial tasks in the various ALM tools, or in a separate planning application, and/or to duplicate information. In some embodiments, experts from different domains of the application lifecycle management (e.g., such a requirements management, testing management, defects management, etc.) may collaborate and understand the developed plan, using the artifacts that the experts may utilize in connection with the ALM tools associated with each respective expert. Further, in some embodiments, updates to the plan may e reflected on the individual ALM tools in near real time, which may in some instances further reduce and/or eliminate the need to duplicate information.

In some implementations, the present disclosure may support agile planning, e.g., by allowing a unified plan to be generated included a single ranked backlog of actionable items to be performed. In some embodiments, the present disclosure may also support a “no-silos” philosophy. For example, a plan generated consistent with some embodiments of the present disclosure may allow disparate actionable items from different ALM tools to be mixed in a single ranking scheme. For example, a particular story (e.g., from a requirements management tool) and the test cases (e.g., from a testing management tool) and defects (e.g., from a defects management tool) associated with the story can be ranked to create a prioritized backlog of actionable items to be performed. As such, it may be possible for a team member to select the next most important item from the prioritized backlog. In this manner, a feature team member may be able to pick the next most important item from the prioritized backlog (such as fixing a defect, or running a test case), e.g., as opposed to picking the next familiar item (e.g., a developer avoiding a test case in favor of a less critical story implementation), which may support the above-mentioned no-silos philosophy.

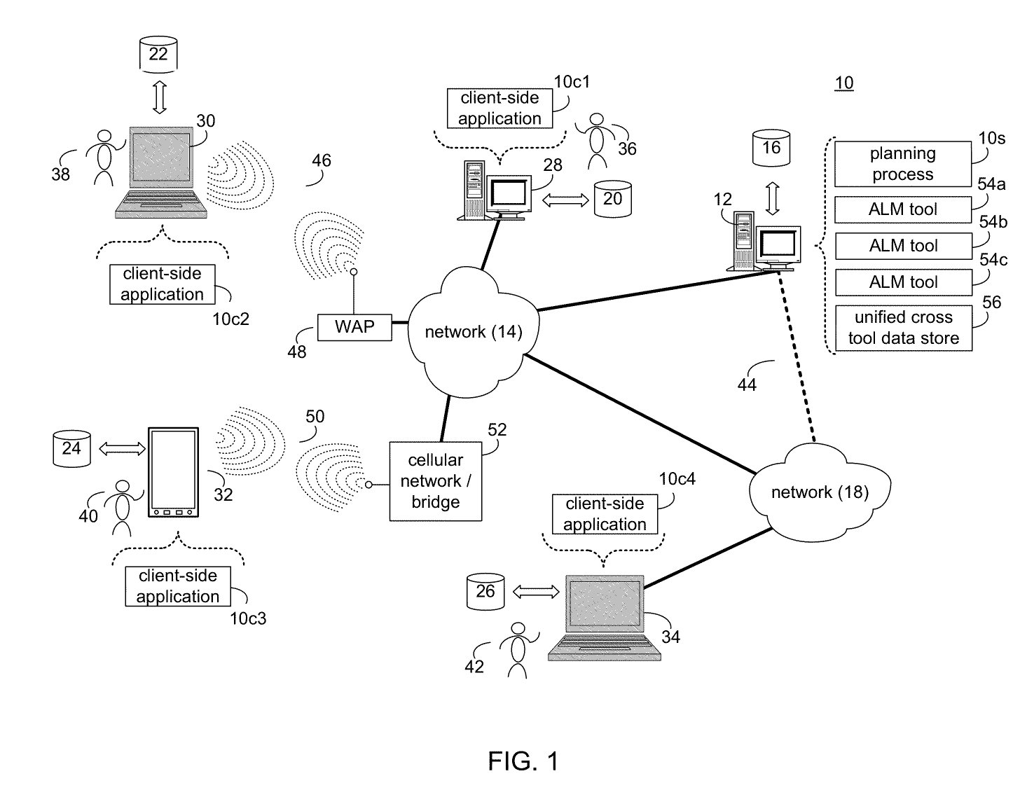

Referring to FIG. 1, there is shown planning process 10. For the following discussion, it is intended to be understood that planning process 10 may be implemented in a variety of ways. For example, planning process 10 may be implemented as a server-side process, a client-side process, or a server-side/client-side process.

For example, planning process 10 may be implemented as a purely server-side process via planning process 10s. Alternatively, planning process 10 may be implemented as a purely client-side process via one or more of client-side application 10c1, client-side application 10c2, client-side application 10c3, and client-side application 10c4. Alternatively still, planning process 10 may be implemented as a server-side/client-side process via screen planning process 10s in combination with one or more of client-side application 10c1, client-side application 10c2, client-side application 10c3, and client-side application 10c4. In such an example, at least a portion of the functionality of planning process 10 may be performed by planning process 10s and at least a portion of the functionality of planning process 10 may be performed by one or more of client-side application 10c1, 10c2, 10c3, and 10c3.

Accordingly, planning process 10 as used in this disclosure may include any combination of planning process 10s, client-side application 10c1, client-side application 10c2, client-side application 10c3, and client-side application 10c4.

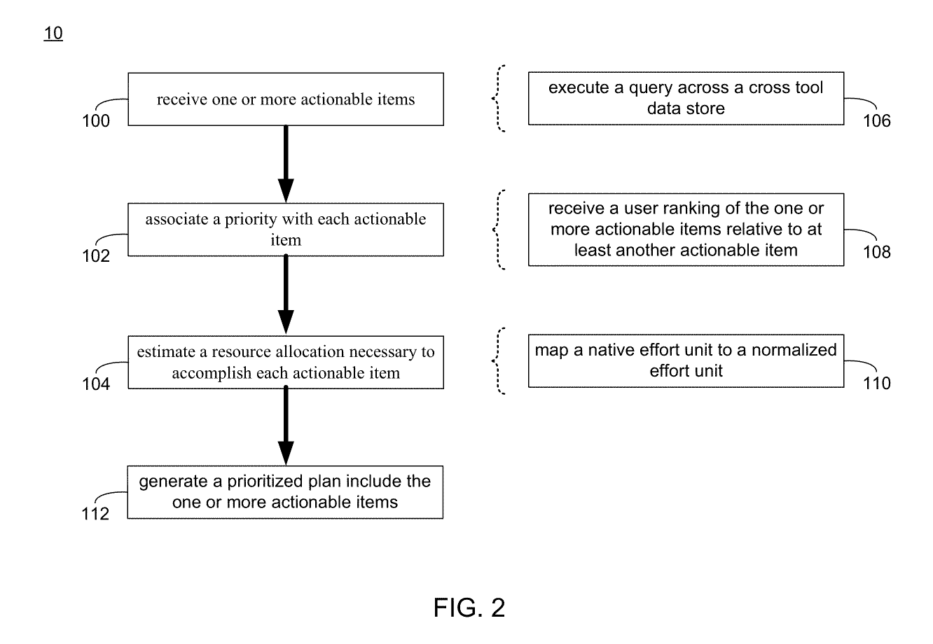

Referring also to FIG. 2, and as will be discussed in greater detail below, planning process 10 may receive 100 one or more actionable items from at least one of a plurality of application lifecycle management tools. Planning process 10 may also associate 102 a priority with each of the one or more actionable items. Planning process 10 may further estimate 104 a resource allocation necessary to accomplish each of the one or more actionable items.

Planning process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, or a dedicated network device.

The instruction sets and subroutines of planning process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of client-side applications 10c1, 10c2, 10c3, 10c4 may include but are not limited to a web browser, or a specialized application (e.g., an application running on a mobile platform). The instruction sets and subroutines of client-side application 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, personal computer 28, laptop computer 30, mobile computing device 32, notebook computer 34, a netbook computer (not shown), a server computer (not shown), a gaming console (not shown), a data-enabled television console (not shown), and a dedicated network device (not shown). Client electronic devices 28, 30, 32, 34 may each execute an operating system.

Users 36, 38, 40, 42 may access planning process 10 directly through network 14 or through secondary network 18. Further, screen capture process 10 may be accessed through secondary network 18 via link line 44.

The various client electronic devices (e.g., client electronic devices 28, 30, 32, 34) may be directly or indirectly coupled to network 14 (or network 18). For example, personal computer 28 is shown directly coupled to network 14. Further, laptop computer 30 is shown wirelessly coupled to network 14 via wireless communication channels 46 established between laptop computer 30 and wireless access point (WAP) 48. Similarly, mobile computing device 32 is shown wirelessly coupled to network 14 via wireless communication channel 50 established between mobile computing device 32 and cellular network/bridge 52, which is shown directly coupled to network 14. WAP 48 may be, for example, an IEEE 802.11a, 802.11b, 802.11g, 802.11n, Wi-Fi, and/or Bluetooth device that is capable of establishing wireless communication channel 46 between laptop computer 30 and WAP 48. Additionally, personal computer 34 is shown directly coupled to network 18 via a hardwired network connection.

In some embodiments, planning process 10 may communicate with, interact with, and/or include a component or module of an application lifecycle management tool (e.g., one or more of ALM tools 54a, 54b, 54c, which may be collectively and/or generally referred to as ALM tools 54). As is generally know, various ALM tools may facilitate support activities relative to software development, software testing, software maintenance, software release management, and the like, throughout the life span of a software product. Examples of ALM tools 54 may include, but are not limited to, a requirements management tool, a testing management tool, a defects management tool, a maintenance management tool, and a change management tool. Various additional and/or alternative ALM tools may equally be utilized. As such, ALM tools 54 may be utilized for managing and/or performing various different activities relative to a software product throughout different stages of the software products life span (e.g., from initial conception of the software product to discontinuation of support for the software product).

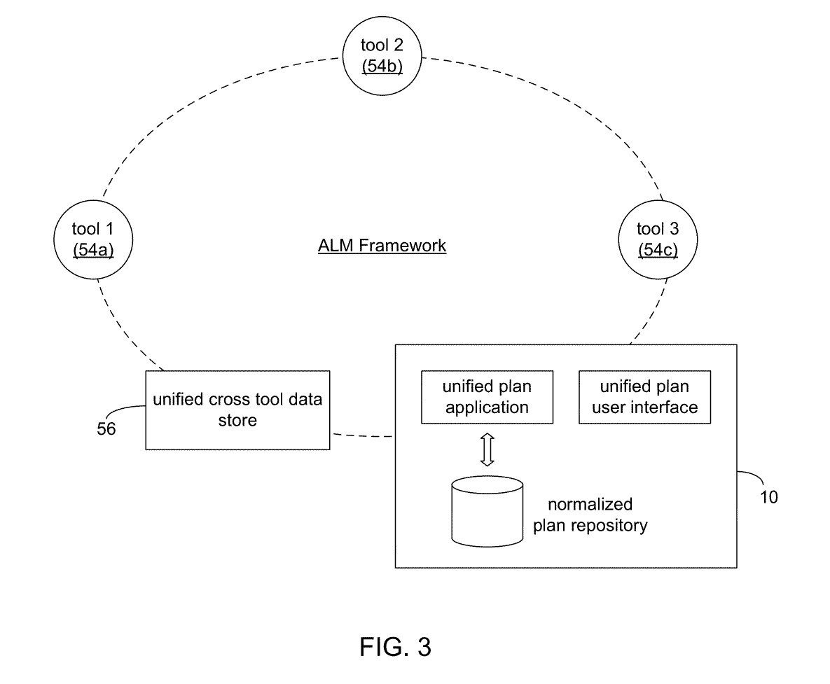

In an embodiment, planning process 10 may communicate with, interact with and/or include a component or module of a unified cross tool data store (e.g., unified cross tool data store 56 such as Lifecycle Query Engine from IBM). Cross tool data store 56 may generally receive information from various different ALM tools (e.g., ALM tools 54a, 54b, 54c, etc.) and may aggregate the received information. In an example, unified cross tool data store 56 may fetch the data from the various different ALM tools, e.g., which may exist in different application lifecycle domains (e.g., requirements management, quality management, defects management, change management, etc.). For example, and as generally shown with reference to FIG. 3, in an embodiment, the various ALM tools (e.g., ALM tools 54a, 54b, 54c) may exist in a common ALM framework, which may provide defined specifications and/or implementations that may allow unified cross tool data store 56 to fetch the data from each of the ALM tools within the ALM framework. As such, the ALM framework may provide specifications for data format expectations. For example, the various ALM tools within the ALM framework may surface data using W3C standards (e.g., Resource Description Framework standards), and may thereby specify resources and artifacts in a predetermined manner, e.g., which may allow unified cross tool data store 56 to fetch and aggregate data from the various ALM tools within the ALM framework.

Consistent with the foregoing, unified cross tool data store 56 may index the data from the various ALM tools within the ALM framework. For example, unified cross tool data store 56 may fetch data from a requirements management tool such as the names of the various requirements for a software product provided by the requirements management tool, an owner associated with each requirement, a story point value for each requirement (e.g., which may generally be an anticipated measure of the work that will be required to complete the requirement), and the like. Unified cross tool data store may similarly collect information from the various other ALM tools associated with the ALM framework, collecting, e.g., tasks provided by the tools, task names, task identifiers, users assigned to the tasks, estimated work to complete the task, etc. The information collected by unified cross tool data store 56 may be stored in a repository associated with unified cross tool data store 56. It will be appreciated that the various different ALM tools within the ALM framework may utilize different nomenclature, terminology, measures of estimated work for completing tasks, and the like for representing different, and even the same, information.

The various information collected by unified cross tool data store 56 from the various ALM tools within the ALM framework may be aggregated into a common repository (e.g., which may reside on storage device 16 associated with server computer 12, and/or may reside on another storage device associated with one or more computing devices). In some situations, the data aggregated within the repository may include linked data. For example, even though various pieces of information within the repository may original from different ALM tools, the data may be linked across tool boundaries. For example, a requirement management tool may have a requirement that may be indicated in the requirement management tool as being implemented by a plan item provided by a change management tool. As such the requirement stored in the repository provided by unified cross tool data store 56 may include a link to the plan item, which may also be stored in the repository. As such, the link data provided by unified cross tool data store 56 may reflect such relationships between data items originating in the various ALM tools.

In some embodiments, the aggregated data from the various ALM tools, which may be provided by unified cross tool data store 56, may facilitate querying information across the various ALM tools via a common repository. For example, a query executed against the repository provided by unified cross tool data store 56 may effectively search information from all of the ALM tools, as the data from all of the ALM tools within the ALM framework may exist in the same repository.

As generally discussed above with reference to FIG. 2, planning process 10 may receive 100 one or more actionable items from at least one of a plurality of application lifecycle management tools. Planning process 10 may also associate 102 a priority with each of the one or more actionable items. Planning process 10 may further estimate 104 a resource allocation necessary to accomplish each of the one or more actionable items.

For example, and with reference to FIG. 3, planning process 10 may receive 100 one or more actionable items from at least one of a plurality of application lifecycle management tools. The actionable items may include any work item that may be completed as an aspect of developing, testing, debugging, maintaining, or otherwise supporting a software product during one or more stages of the lifecycle of the software product. The actionable items received 100 from at least one of the plurality of application lifecycle management tools may be utilized for constructing a plan for supporting or advancing the software product through one or more stages of the lifecycle of the software product. Further, the play developed using the one or more received 100 actionable items may include items across multiple application lifecycle domains. For example, the plan may include actionable items from a requirements management tool, actionable items form a quality management tool, actionable items from a defect management tool, etc. As such, the plan may contemplate and/or include actionable items across the various lifecycle management domains of the software product.

As generally described above, the application lifecycle management tools (e.g., ALM tools 54a, 54b, 54c, etc.) may be provided to support various stages and domains of application lifecycle management, such as requirements management, quality assurance and testing, defect management, change management, release management, architecture and development, and the like. Consistent with the illustrated embodiment, planning process 10 may receive 100 one or more actionable items from any one of the application lifecycle management tools, and/or may receive one or more actionable items from more than one of the application lifecycle management tools. As such, planning process 10 may be capable of working with items received from different application lifecycle tools that may be implemented in connection with different application lifecycle domains. In some situations, the different tools may utilize different nomenclature, units of work, terminology, actionable item division, and the like. Further, in some situations one or more of the application lifecycle management tools may be provided by different vendors, and may not readily interoperate.

Receiving 100 the one or more actionable items may include executing 106 a query across a unified cross tool data store including application lifecycle management tool artifacts. For example, and as discussed above, unified cross tool data store 56 may fetch data from the various application lifecycle management tools (e.g., ALM tools 54a, 54b, 54c, etc.) within the ALM framework, even when the disparate ALM tools 54 (collectively) may be provided by different vendors, utilize different terminology, different units of work, etc. The data fetched from the various ALM tools may be stored in a repository provided by unified cross too data store 56. In an embodiment, planning process 10 may receive 100 the one or more actionable items by executing 106 a query across the repository provided by unified cross tool data store 56. The query may, for example, identify actionable items from the various ALM tools that meet the query requirements.

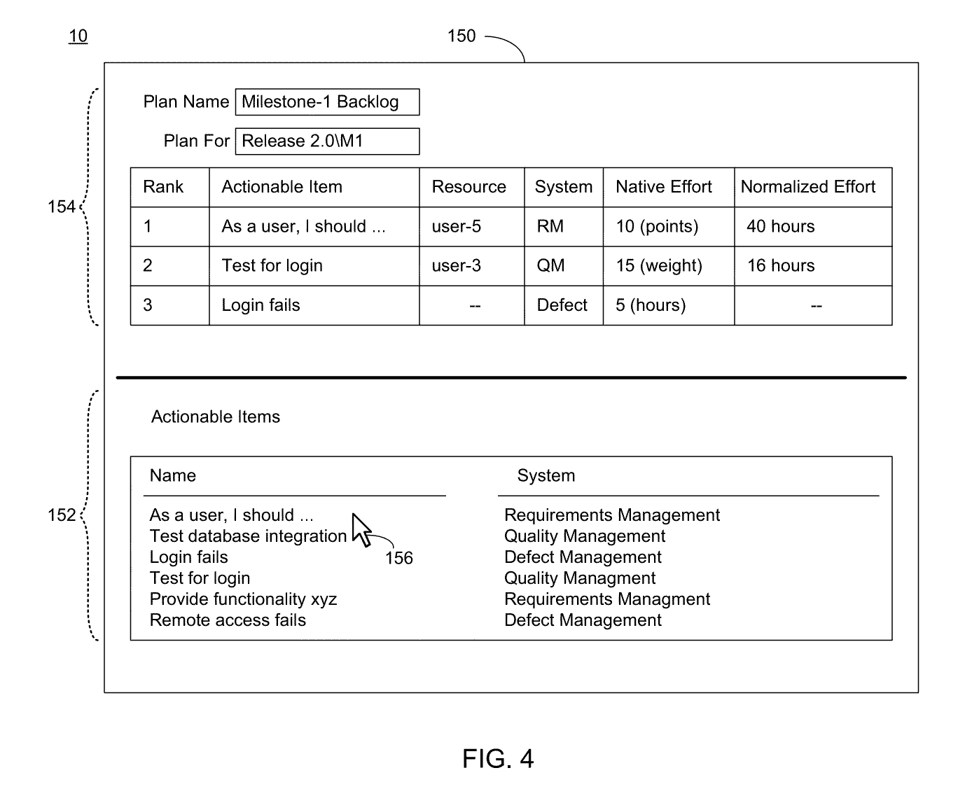

For example, planning process 10 may query the repository associated with unified cross tool data store 56. An example of a query executed across the repository may include, a query for all requirements that are not implemented by a plan item, all requirements that are implemented by plan items and that have completed testing, or the like. Various queries may be limited to specific ALM tools, may be expansive across all ALM tools, and/or may be constructed according to any other preferences or needs. As shown in FIG. 3, and referring also to FIG. 4, in an embodiment planning process 10 may support a unified plan user interface, e.g., that may allow a user constructing a plan for a software development project/software lifecycle (which is intended to encompass all stages of software development, release, support, and maintenance) to interact with the various artifacts from the various ALM tools. For example, as shown, in FIG. 4, in an embodiment, user interface 150 may be provided. In response to a query executed via planning process 10, planning process 10 may receive 100 one or more actionable items from one or more ALM tools (e.g., one or more of ALM tools 54a, 54b, 54c), which may be displayed in an actionable items list (e.g., actionable items list 152). As shown, actionable items list may include various actionable items that may be received from various different ALM tools (e.g., denoted in the “System” column), such as a requirements management too, a quality management tool, and a defect management tool. Actionable items may be received 100 for various additional/alternative ALM tools.

While the foregoing example describes querying a repository associated with unified cross tool data store 56, in some embodiments planning process 10 may receive 100 one or more actionable items from one or more application lifecycle management tools directly. In some such embodiments, planning process 10 may fetch artifacts from the various application lifecycle management tools.

Planning process 10 may also associate 102 a priority with each of the one or more actionable items. For example, consistent with some implementations, planning process 10 may be utilized to develop a plan for use in an agile development paradigm. In some situations, and agile development paradigm may contemplate that different tasks from different application lifecycle domains may be required during a software development project/software lifecycle, and that the various tasks from the various application lifecycle domains may occur at the same time, at overlapping times, and/or at different times that may be independent of the application lifecycle domain. Further, in some situations and agile development paradigm may utilize a prioritized backlog, e.g., which may include a list of task items to be performed relative to the software development project that may be ranked according to the relative importance of each task item. The agile development paradigm may dictate that the task items be completed according to the priority (e.g., may be completed in the order of the prioritized backlog) and with a predetermined quality. In an embodiment, planning process 10 may support and/or facilitate an agile planning paradigm by associating 102 a priority with each of the one or more actionable items.

Associating 102 the priority with each of the one or more actionable items may include receiving 108 a user ranking of the one or more actionable items relative to at least another actionable item. For example, a user (such as user 36) may drag-and-drop actionable items from actionable items list 152 to ranked plan 154, e.g., using onscreen pointer 156 (which may be controlled by a pointing device such as a mouse), or another suitable means. The user may drag and drop the various actionable items into ranked plan 154 according to a desired relative priority. Further, the user may also change the priority associated 102 with each of the one or more by dragging and dropping the various actionable items within ranked plan 154, e.g., to change the relative priority of the items within ranked plan 154. A user may add additional actionable items to ranked plan 154 (e.g., by dragging additional actionable items into ranked plan 154) and/or may remove actionable items from ranked plan 154. The actionable items may be inserted into ranked plan 154 according to a desired priority of each actionable item. Additionally/alternatively the relative priority of the actionable items within ranked plan 154 may be modified after one or more of the actionable items have been added to ranked plan 154. Accordingly, planning process 10 may associate 102 a priority with each of the one or more actionable items in ranked plan 154 based upon, at least in part, a received 108 user ranking of the one or more actionable items. It will be appreciated that user ranking may be received based upon inputs other than drag-and-drop of the actionable items.

Planning process 10 may further estimate 104 a resource allocation necessary to accomplish each of the one or more actionable items. For example, the one or more received 100 (e.g., from ALM tools 54a, 54b, 54c and/or from unified cross tool data store 56) actionable items may include a resource allocation that may be indicative of the amount of work that may be necessary to complete the actionable item and/or may be indicative of the complexity associated with the actionable item. Estimating 104 the resource allocation necessary to accomplish each of the one or more actionable items may include mapping 110 a native effort unit associated with each of the one or more actionable items with a normalized effort unit. For example, different ALM tools may utilized different native effort units (e.g., as shown in “Native Effort” column of ranked plan 154 in FIG. 4) to express or quantify the resource allocation for completing the actionable item and/or for expressing the relative complexity of the actionable item. For example, a requirements management tool may express the complexity of a task and/or the amount of effort required to complete the task in terms of “story points.” Similarly, a quality management took may express the complexity of a task and/or the amount of effort required to complete the task in terms of “test weights.” Further, a defect management tool may express the complexity of a task and/or the amount of effort required to complete the task in terms of “hours.” Various different ALM tools may utilized additional and/or different native effort units for expressing the complexity of a task and/or the amount of effort required to complete the task. In an embodiment, planning process 10 may map 110 the native effort units associated with each actionable item to a normalized effort unit (such as hours, or another desired normalized effort unit). Mapping 110 the native effort units to normalized effort units may, for example, facilitate planning, e.g., by expressing all effort for completing actionable items in the same units, regardless of the native units utilized by the individual ALM tools. The normalized effort units may be included, e.g., in “Normalized Effort” column of ranked plan 154 in FIG. 4.

Mapping 110 the native effort unit to the normalized effort unit may be based upon, at least in part, historical data associated with the performance of the native effort unit. For example, in some situations there may not be a reliable conversion factor between one or more native effort units utilized by an ALM tool and the normalized effort units. In an embodiment, planning process 10 (e.g., and/or unified cross tool data store 56 and/or another process or application) may track the performance and completing of actionable items over time. As such, planning process 10 may be capable of accessing historical data regarding actionable items, native effort units associated with the actionable items and normalized effort units required to complete the actionable items. For example, historically each story point of effort to complete a requirements management tool task may require four hours of work. Therefore, an actionable item having a native effort of 10 story points may be mapped 110 to 40 hours of work (e.g., a normalized effort unit). Similar mappings 110 based upon historical data may be carried out for other native effort units utilized by other ALM tools.

Native effort units may be mapped 110 to normalized effort units based upon, at least in part, historical data associated with the performance of native effort units across all users working on actionable items. Further, in some embodiments, the historical data associated with the performance of the native unit may be based upon, at least in part, one or more identified users. For example, in some implementations, agile development paradigms may utilize feature teams, in which any team member may be called upon to work on any actionable item, e.g., without regard for a particular specialty of the team member. It will be appreciated that based upon background, experience, etc., of the various team members, different team members may require more or less time to complete a given actionable item. For example, team member having extensive experience in testing may be capable of completing a 15 test weight task in 10 hours, while a team member having extensive experience in developing requirements, but less experience in testing, may only be capable of completing the 15 test weigh task in 18 hours. Accordingly, in some embodiment, planning process 10 may map 110 native effort units to normalized effort units based upon, at least in part, historical data associated with the performance of native effort units (and/or task items) by a particular individual. For example, the historical data may be based upon, at least in part, how long is has previously taken a particular individual to perform particular tasks. Accordingly, it may be possible to achieve relatively reliable estimates 104 of resource allocation associated with each actionable item based on the mapping 110 utilizing historical data for specific individuals.

As shown in ranked plan 154, in some situations a user creating the plan may be capable of associating specific individuals (e.g., under “Resource” column) with specific actionable items. In some embodiments, a particular user may be associated with a specific actionable item within the ALM tool from which the actionable item arises. In such an embodiment, receiving 100 the actionable item may include receiving an indication of the specific individual associated with the specific actionable item. According to either situation, planning process 10 may estimate resource allocation associated with each actionable item based upon a mapping of native effort units to normalized effort units based upon, at least in part, historical data for the specific individual associated with the specific actionable item. It will be appreciated that if the specific individual associated with a specific actionable item is chanted, the estimated 104 normalized effort for completing the actionable item may be updated (e.g., based upon historical data for the changed individual).

Planning process 10 may generate 112 a prioritized plan including the one or more actionable items ranked based upon, at least in part, the associated priority for each of the one or more actionable items. For example, once a user has dragged (or otherwise imported) desired actionable items into ranked plan 154 and has indicated a desired relative priority of each actionable item and, if appropriate, associated a user with each actionable item, planning process 10 may generate 112 a prioritized plan. The prioritized plan may include, for example, a prioritized backlog that may be utilized in connection with an agile development paradigm. In some embodiments, the prioritized plan may be saved in the normalized plan repository (e.g., which may reside on storage device 16 associated with server computer 12 and/or on another storage device. In some embodiments, if changes are made to the prioritized plan, (e.g., a change to a title of a an actionable item, a change in a resource associated with an actionable item, or the like), the change may be propagated back to the original, native ALM tool from which the actionable item arises (e.g., via defined URI associated with the plan entry). As such, the artifacts within the native ALM tools may remain consistent with the prioritized plan.

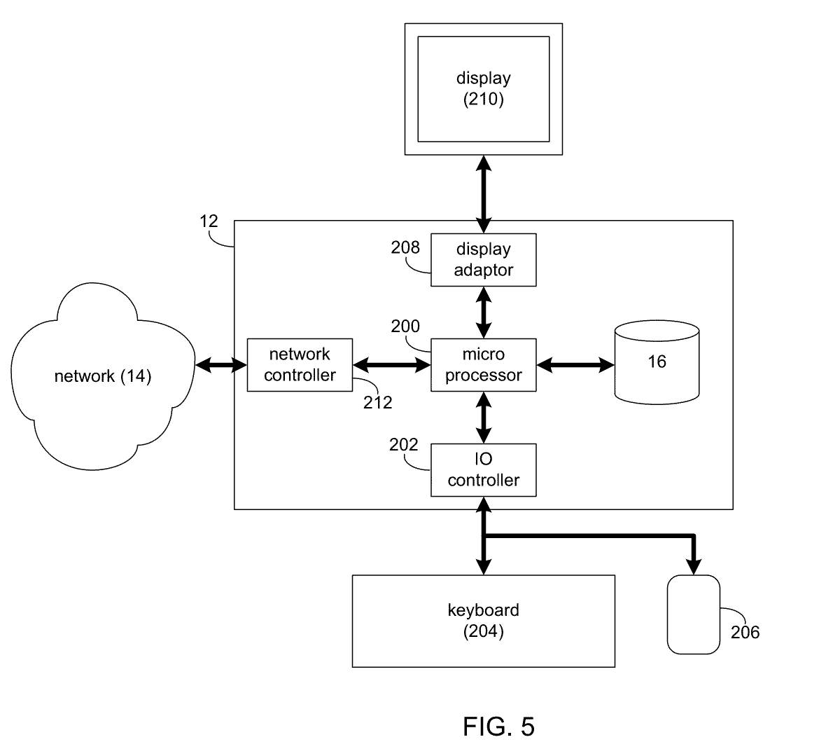

Referring also to FIG. 5, there is shown a diagrammatic view of computing system 12. While computing system 12 is shown in this figure, this is for illustrative purposes only and is not intended to be a limitation of this disclosure, as other configuration are possible. For example, any computing device capable of executing, in whole or in part, planning process 10 may be substituted for computing device 12 within FIG. 5, examples of which may include but are not limited to client electronic devices 28, 30, 32, 34.

Computing system 12 may include microprocessor 200 configured to e.g., process data and execute instructions/code for screen capture process 10. Microprocessor 200 may be coupled to storage device 16. As discussed above, examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices. IO controller 202 may be configured to couple microprocessor 200 with various devices, such as keyboard 204, mouse 206, USB ports (not shown), and printer ports (not shown). Display adaptor 208 may be configured to couple display 210 (e.g., a CRT or LCD monitor) with microprocessor 200, while network adapter 212 (e.g., an Ethernet adapter) may be configured to couple microprocessor 200 to network 14 (e.g., the Internet or a local area network).

As will be appreciated by one skilled in the art, the present disclosure may be embodied as a method (e.g., executing in whole or in part on computing device 12), a system (e.g., computing device 12), or a computer program product (e.g., encoded within storage device 16). Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium (e.g., storage device 16) having computer-usable program code embodied in the medium.

Any suitable computer usable or computer readable medium (e.g., storage device 16) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, C#.NET, PHP, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor (e.g., processor 200) of a general purpose computer/special purpose computer/other programmable data processing apparatus (e.g., computing device 12), such that the instructions, which execute via the processor (e.g., processor 200) of the computer or other programmable data processing apparatus, create means for implementing the functions/acts specified in the flowchart and/or block diagram block or blocks.

These computer program instructions may also be stored in a computer-readable memory (e.g., storage device 16) that may direct a computer (e.g., computing device 12) or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer (e.g., computing device 12) or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1. A computer-implemented method comprising:
receiving, by a computing device, one or more actionable items from at least one of a plurality of application lifecycle management tools;
associating, by the computing device, a priority with each of the one or more actionable items; and
estimating, by the computing device, a resource allocation necessary to accomplish each of the one or more actionable items.

2. The computer-implemented method of claim 1, wherein receiving the one or more actionable items includes receiving the one or more actionable items includes executing a query across a cross tool data store including application lifecycle management tool artifacts.

3. The computer-implemented method of claim 1, wherein associating the priority with each of the one or more actionable items includes receiving a user ranking of the one or more actionable items relative to at least another actionable item.

4. The computer-implemented method of claim 1, wherein estimating the resource allocation necessary to accomplish each of the one or more actionable items includes mapping a native effort unit associated with each of the one or more actionable items with a normalized effort unit.

5. The computer-implemented method of claim 4, wherein mapping the native effort unit to the normalized effort unit is based upon, at least in part, historical data associated with the performance of the native effort unit.

6. The computer-implemented method of claim 5, wherein the historical data associated with the performance of the native unit is based upon, at least in part, one or more identified users.

7. The computer implemented method of claim 1, further comprising generating a prioritized plan including the one or more actionable items ranked based upon, at least in part, the associated priority for each of the one or more actionable items.

8.-20. (canceled)
